(19) United States
(12) Patent Application Publication
(10) Pub. No.: US 2012/0032779 A1
(43) Pub. Date: Feb. 9, 2012

(54) METHOD AND APPARATUS FOR ACCESSING CONTENT WITHIN A DEVICE

(75) Inventor: Mikael Jaakkola, Turku (FI)

(73) Assignee: NOKIA CORPORATION, Espoo (FI)

(21) Appl. No.: 12/849,905

(22) Filed: Aug. 4, 2010

(51) Int. Cl. G06F 7/04

(52) U.S. Cl. 340/5.54

(57) ABSTRACT

An apparatus includes at least one a processor, and at least one memory including computer program code, the at least one memory and the computer program code configured to, with the at least one processor, cause the apparatus at least to determine that a character input has been recognized by an apparatus, determine that an audible word starting with the character has been recognized by the apparatus, and initiate an unlocking operation of the apparatus.

### BACKGROUND

Many electronic devices may be capable of operating in a “locked” state, where the functions of the device are restricted or rendered inoperable. The locked state is typically intended to prevent misuse or inadvertent activation of the functions of the device. Generally, the locked state may be initiated automatically or as a result of receiving an input. In the locked state, certain functions of the device may be prohibited, for example, outgoing communications, certain input operations, and access to certain applications. The device may exit the locked state as a result of some operation, such as receiving a communication, or upon recognizing an input sequence. The input sequence typically involves pressing one or more keys of the device in sequence, for example, entering a passcode, personal identification code, “PIN” code, or a simple key sequence such as an “Unlock” and “Function” key.

Problems may arise if it is necessary to access content within the device and the unlock operation is difficult or forgotten. For example, at least one problem that can arise is if an owner forgets the unlock operation. In such a case, a legitimate or otherwise authorized access to content within the device is prohibited. As another example, a user, while authorized to use a particular device, may not know the unlock operation and thus be unable to operate the device and access the content therein. Using a mobile phone as a practical example, if there is a need to find a contact number urgently, several steps may be required to unlock the phone and retrieve the number to make the call.

It would be desirable to provide an alternative technique for accessing content within a device that addresses these and other problems.

### SUMMARY

In an embodiment, an apparatus is disclosed including at least one processor and at least one memory including computer program code, the at least one memory and the computer program code configured to, with the at least one processor, cause the apparatus at least to determine that a character input has been recognized, determine that an audible word starting with the character has been recognized, and initiate an unlocking operation of the apparatus.

In an embodiment, a method is disclosed including determining that a character input has been recognized, determining that an audible word starting with the character has been recognized, and initiating an unlocking operation of the apparatus.

### BRIEF DESCRIPTION OF THE DRAWINGS

The embodiments presently disclosed herein are explained in the following description, taken in connection with the accompanying drawings, wherein:

FIG. 1 illustrates a block diagram of an exemplary embodiment in the form of an apparatus;

FIG. 2 shows a flow diagram illustrating the operations of the apparatus;

FIG. 3 illustrates another exemplary embodiment in the form of a computing device;

FIG. 4 shows a flow diagram illustrating exemplary operations of the computing device;

FIGS. 5A and 5B illustrate another exemplary embodiment in the form of a mobile communications device;

FIG. 6 in combination with FIG. 7 illustrates exemplary operations of the mobile communications device;

FIG. 8 shows an exemplary embodiment where the mobile communications device 500 is configured to communicate with a mobile telecommunications network; and

FIG. 9 shows the operations of the mobile communications network in providing an access application as a service.

### DETAILED DESCRIPTION

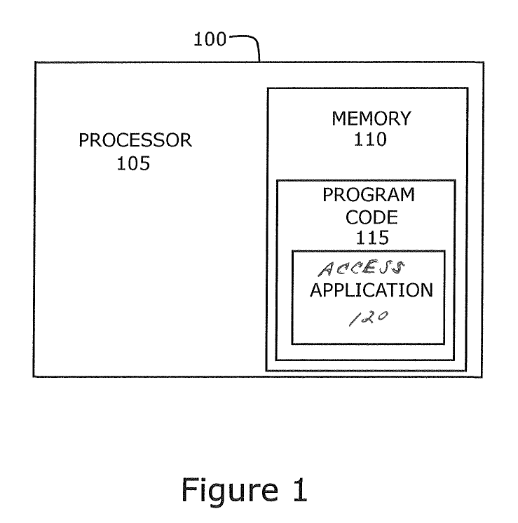

FIG. 1 illustrates a block diagram of an exemplary embodiment in the form of an apparatus 100. As a non-limiting example, the apparatus 100 may be an integrated circuit. Apparatus 100 includes a processor 105 and a memory 110 including computer program code 115. The memory 110 and the program code 115 are configured to, with the processor 105, cause the apparatus 100 at least to recognize a character input, recognize an audible word starting with the character, and unlock the apparatus 100. The processor 105, and the other processors disclosed in this application, may include one or more of a microprocessor, a digital signal processor, a special purpose computer chip, a field programmable gate array, a controller, an application specific integrated circuit, a computer or any suitable processor. The memory 110, and the other memories disclosed in this application, may include any non-transitory computer readable medium, for example, one or more of a magnetic media, diskette, disk, computer hard drive, optical media, compact disk, digital versatile disk, semiconductor, read-only memory, random access memory, or any suitable program code storage medium. The memory 110 and the program code 115 may also be configured to, with the processor 105, cause the apparatus 100 at least to determine that a character input has been recognized, determine that an audible word starting with the character has been recognized, and initiate an unlocking operation. The program code 115 may include an access application 120 configured to, with the processor 105, cause the apparatus 100 to recognize a character input, recognize an audible word starting with the character, and unlock the apparatus 100. Upon unlocking, the apparatus 100 may provide access to content associated with the recognized word. The access to content may include executing a function utilizing the associated content.

In the locked state, the apparatus 100 may have limited functionality but retains the ability to recognize a character input and an audible input. Upon recognizing the character input and an audible input comprising a word starting with the input character, the apparatus 100 unlocks, that is, at least gains the capacity to provide content related to the recognized word. Alternately, the apparatus 100 may achieve additional functionality in addition to the capacity to provide content related to the recognized word, or may become fully functional. The content related to the recognized word may include any relevant information as explained below.

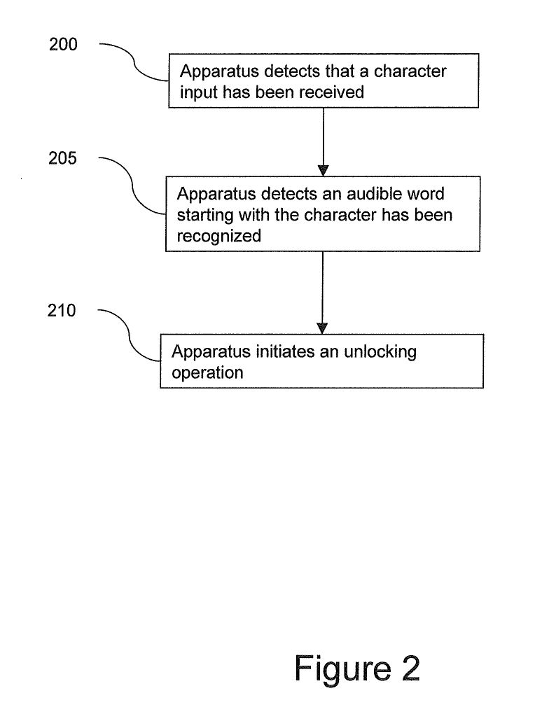

FIG. 2 shows a flow diagram illustrating this process. In block 200, the apparatus 100 detects that a character input has been received. In block 205 the apparatus 100 detects that an audible word staring with the character has been recognized, and in block 210, the apparatus 100 initiates an unlocking operation.

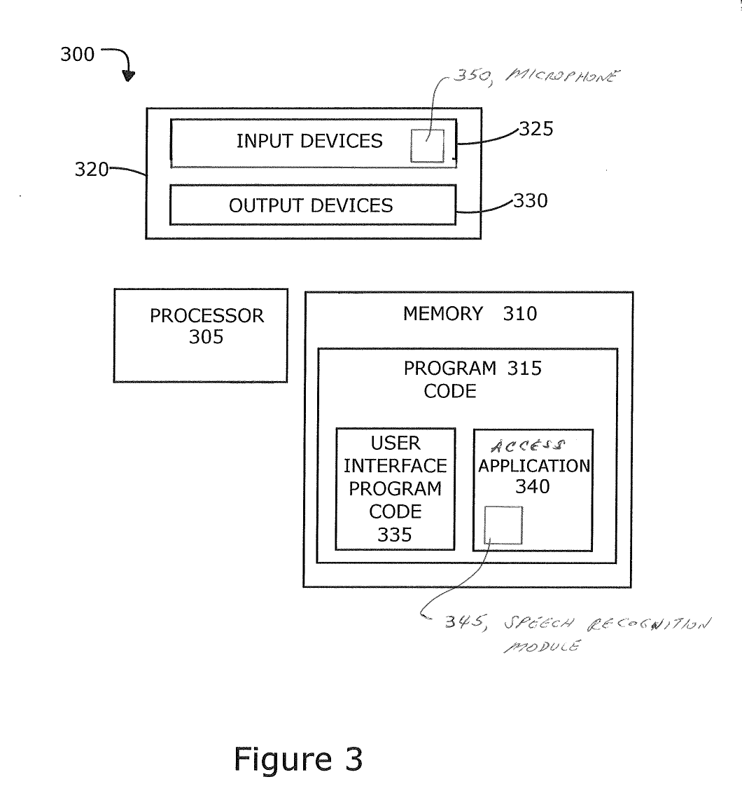

FIG. 3 illustrates another exemplary embodiment in the form of a computing device 300. Apparatus 100 may be included as part of this embodiment. Computing device 300 may be a personal computer, a tablet computer, touch pad device, Internet tablet, a laptop, desktop computer or any suitable computing device. Computing device 300 may be fixed or portable and typically includes a processor 305, a memory 310 with computer program code 315, and a user interface 320. The user interface 320 may generally include user interface circuitry and the program code 315 may include user interface program code 335 for controlling the user interface 320. The user interface generally includes one or more input devices 325 and one or more output devices 330. The input and output devices may include one or more of a keyboard, a number of hard or soft keys, a display, a touch screen, or any other devices suitable for receiving input and for providing output. The input devices may also include a sound sensing device, for example, a microphone 350 for receiving audible input. The program code 315 includes an access application 340 for unlocking the computing device 300 and providing access to content within the device 300. The program code may also include a speech recognition module for analyzing audible information collected by the microphone 350 and recognizing words occurring in the audible information.

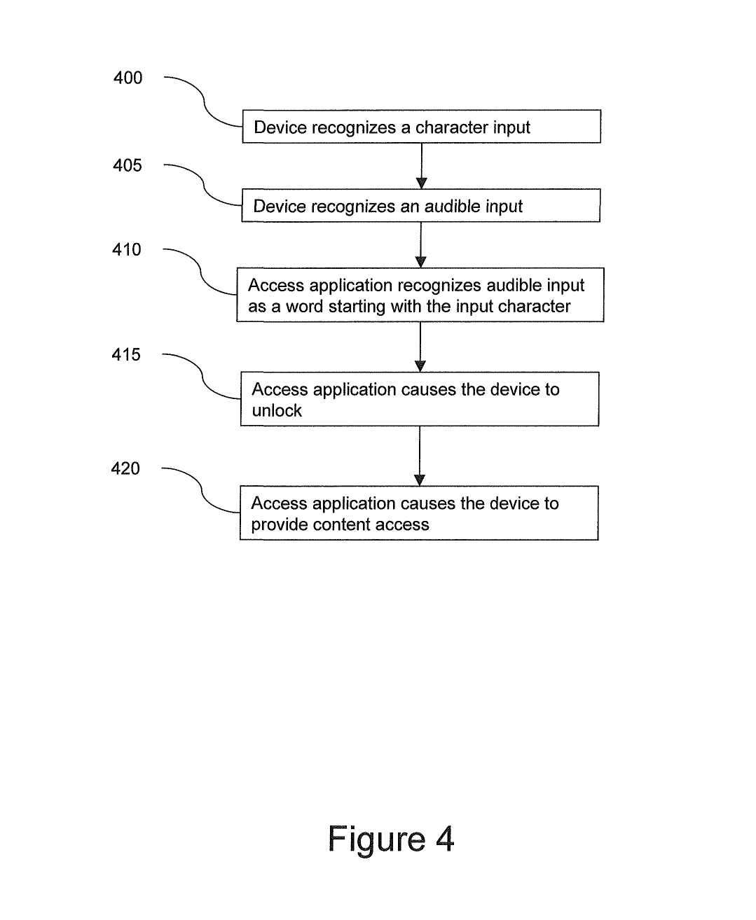

FIG. 4 shows a flow diagram illustrating exemplary operations of the computing device 300. In block 400, the computing device recognizes a character input. As a non-limiting example, the character input may be received from the keyboard, touch screen, hard keys or other appropriate part of the input devices 325. The character input may be any recognizable character and may be input using a single keystroke or a combination of keystrokes as required. In some instances, there may be multiple characters associated with a particular key. The character input may be achieved by pressing the key multiple times, thus cycling through the different characters associated with the particular key. Alternately, the computing device may consider each associated character as the input character and accept any word that starts with any of the associated characters. As a further alternative, pressing a specific key may initiate the access application and a subsequent key press may represent the character input. Still further, a key press that exceeds a preset time may be accepted as a character input. As yet another alternative, the character may be input by drawing a depiction of the character on the touch screen if the computing device 300 is so equipped.

In block 405, the device recognizes an audible input. Generally, the audible input is received by microphone 350. In block 410, the access application analyses the audible input and determines if the audible input is a word starting with the input character. In one aspect of this embodiment, the speech recognition module 345 performs the analysis. In block 415, upon recognizing that the audible input is a word starting with the input character, the access application 340 causes the computing device to unlock.

Upon causing the computing device to unlock, the access application causes the computing device to provide access to content associated with the recognized word, as shown in block 420. Content may include any information that may be stored within the computing device, for example, in memory 310. Content may also include any information that may be available to computing device, for example, from external sources. Content may further include one or more applications provided by the computing device. For example, an application may be associated with the recognized word and, upon recognizing an audible input as a word starting with the input character, the computing device may invoke or initialize the application.

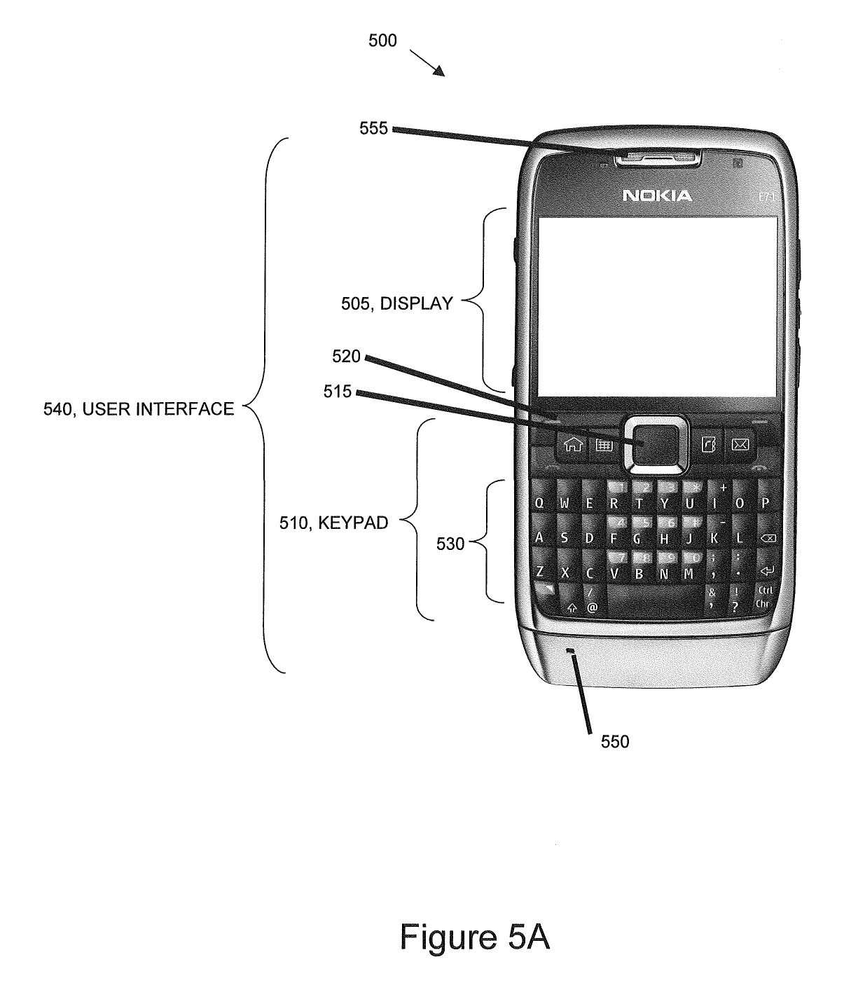

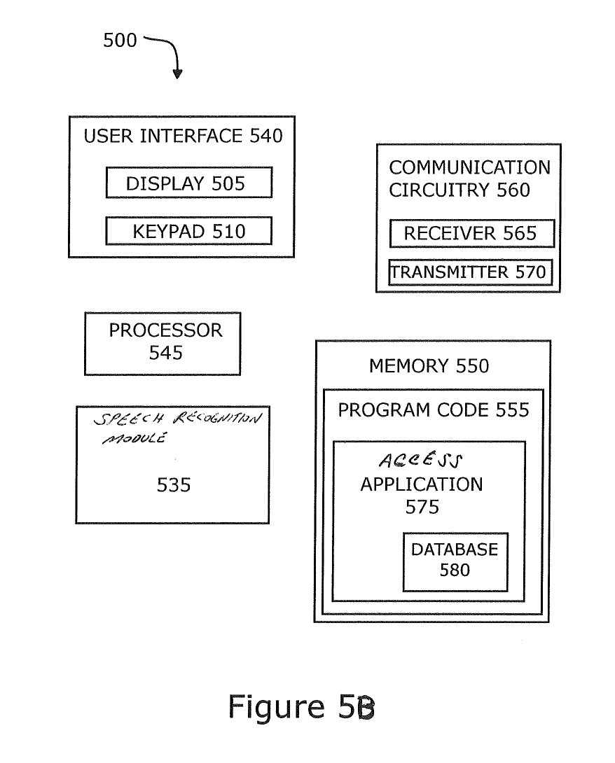

FIG. 5A illustrates another exemplary embodiment in the form of a mobile communications device 500. The computing device 300 may be included as a part of the mobile communication device 500. The mobile communications device 500 may be a mobile terminal, a cellular/mobile phone, a multimedia device, a personal communicator, a personal digital assistant, or any other suitable device. Mobile communications device 500 includes a user interface 540 with a display 505 and a keypad 510. The keypad 510 may include any suitable input devices such as, for example, a multi-function/scroll key 515, soft keys 520 and alphanumeric keys 530. Mobile communications device 500 also includes an image capture device 535 such as a camera as a further input device. The display 505 may include a touch screen and a graphical user interface. The user interface may also include a microphone 550 and a speaker 555 for inputting and outputting speech and oral commands.

FIG. 5B illustrates a block diagram of the mobile communications device 500. As mentioned above, the device 500 includes a user interface 540 with a display 505 and a keypad 510. The mobile communications device 500 also includes one or more processors 545 and memories 550 including computer program code 555 that further includes an access application 575, similar to access application 340, for detecting a character input and a word starting with the input character for unlocking the mobile communications device 500. The mobile communications device 500 may also include a speech recognition module 535, which may be part of or separate from access application 575. The mobile communications device 500 may also include communication circuitry 560 for exchanging information with other devices. The communication circuitry 560 generally includes a receiver 565 and a transmitter 570 for network communication. The communication circuitry 560 is generally configured to allow the mobile communications device 500 to receive and send communications and messages, such as voice transmissions, text messages, chat messages, multimedia messages, still images, video and email, over a network, such as a wired or wireless network.

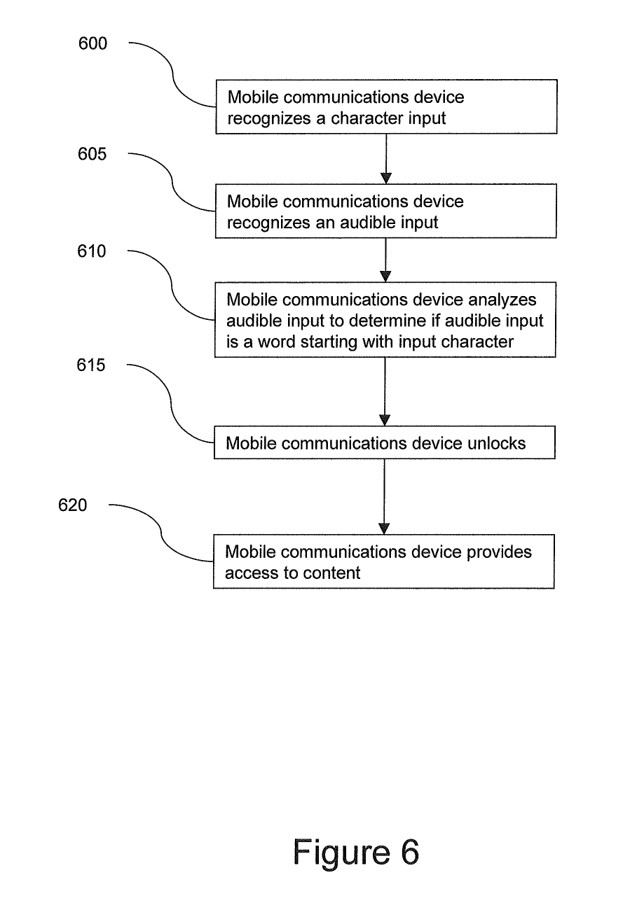

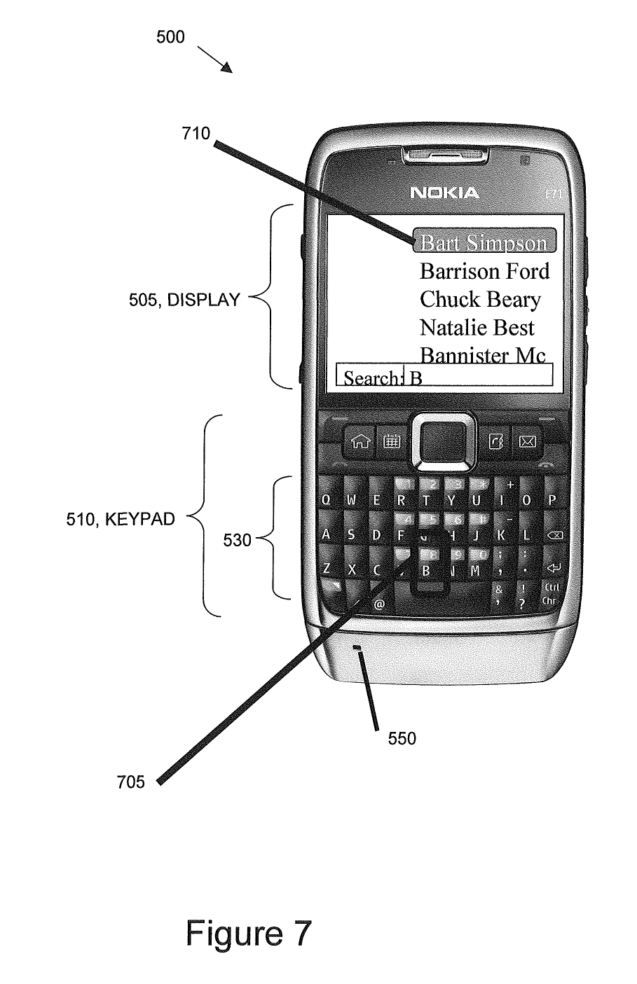

FIG. 6 in combination with FIG. 7 illustrate exemplary operations of this embodiment. In block 600, the mobile communications device 500 recognizes a character input. The character input may be received from the alphanumeric keys 530, the display 505 if implemented as a touch screen, or other appropriate part of the user interface 540. The character input may be any recognizable character and may be input using a single keystroke or a combination of keystrokes as described above. As an alternative, similar to computing device 300 above, the character may be input by drawing a depiction of the character on the display if the mobile communications device 500 is so equipped. In this example, the character input is provided as a press of the “B” key 705.

In block 605, the mobile communications device recognizes an audible input. In this embodiment, the audible input is received by microphone 550. In block 610, the access application 575 analyses the audible input and determines if the audible input is a word starting with the input character. In this embodiment, the speech recognition module 535 performs the analysis and the audible input is the spoken word “Bart.” In block 615, upon recognizing that the audible input is a word starting with the input character, the access application 575 causes the mobile communications device to unlock.

In block 620, upon causing the mobile communications device to unlock, the access application 575 causes the mobile communications device to provide access to content associated with the recognized word. As shown in the example illustrated in FIG. 7, the content associated with the character input “B,” in this case, a list of names, is provided on the display 505. The list of names could be generated from a phonebook, a contact list, or any other source of information. The content associated with the word “Bart,” that is, the name “Bart Simpson” 710, is highlighted on the display.

The content may include any information that may be stored within the mobile communications device, and any information that may be available to the mobile communications computing device, for example, from external sources. The content may further include one or more applications provided by the mobile communications device. For example, an application may be associated with the recognized word and, upon recognizing an audible input as a word starting with the input character, the mobile device may invoke or initialize the application. As another example, the mobile device may invoke a calendar application and show all appointments associated with the word “Bart” or initiate an appointment entry for “Bart.” As still another example, the mobile device may invoke a messaging application and initiate a message for “Bart.”

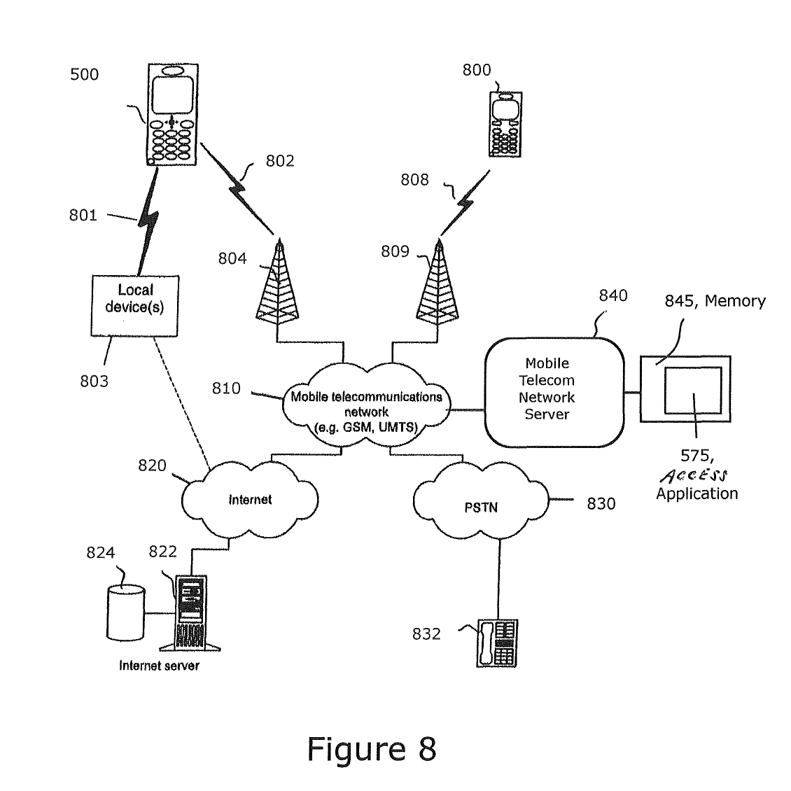

FIG. 8 shows an exemplary embodiment where the mobile communications device 500 is configured to communicate with a mobile telecommunications network 810 and the access application 575 is provided as a service by the mobile telecommunications network 810. In addition to the mobile communication device 500, other mobile terminals 800 may be connected to the mobile telecommunications network 810 through radio frequency (RF) links 802, 808 via base stations 804, 809. The mobile telecommunications network 810 may be in compliance with any commercially available mobile telecommunications standard such as for example the global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 810 may be operatively connected to a wide-area network 820, which may be the Internet or a part thereof. An Internet server 822 has data storage 824 and is connected to the wide area network 820. The server 822 may host a worldwide web/wireless application protocol server capable of serving worldwide web/wireless application protocol content to the mobile terminal 500. A mobile telecommunications network server 840 has a memory 845 and is also connected to the mobile telecommunications network 810 A public switched telephone network (PSTN) 830 may be connected to the mobile telecommunications network 810, and one or more telephone terminals 832 may also be connected to the public switched telephone network 830. The mobile terminal 500 may also be configured for communicating to a device 803 via a link 801, including, for example, one or more of a piconet, Bluetooth™, USB, IEEE 802.11, RS-232, or any other suitable link. In this embodiment, the access application 575 may be located as computer program code in a non-transitory computer readable medium in the memory 845.

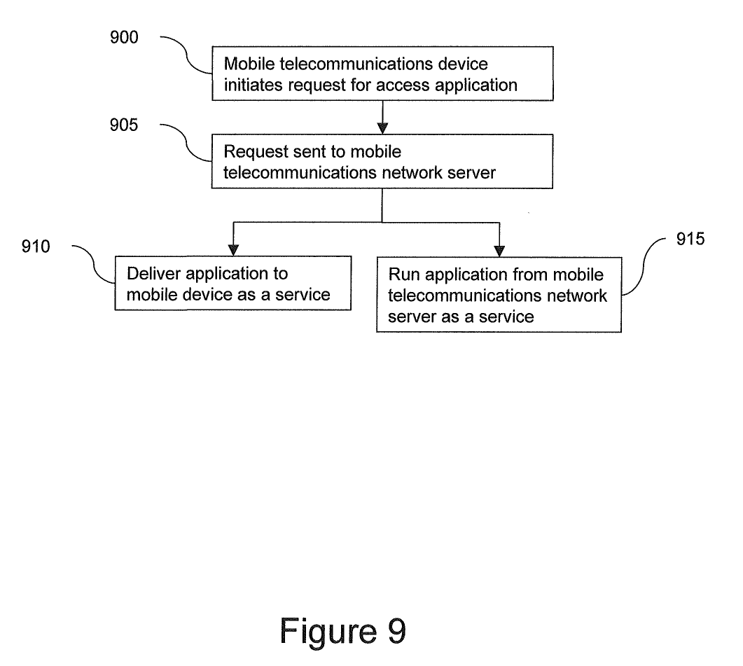

FIG. 9 shows the operations of mobile communications network 810 in providing the access application 545 as a service. In block 900, a request for initiation of the access application is generated at the mobile telecommunications device 500. In block 905, the request is communicated to the mobile telecommunications network server 840 though the mobile telecommunications network 810. In block 910, the access application may optionally be delivered or downloaded to the mobile device 500 and may operate as described above with respect to the mobile communication device embodiment. There may be a charge or fee for delivering the application. Alternately, as shown in block 915, the access application 575 may be run from the mobile telecommunications network server 840, where the memory 845 of the mobile telecommunications network server operates as the memory 550 of the mobile communication device 500 and provides the functions of the access application 575 over the mobile telecommunications network 810. As a further alternative, the mobile communication device 500 and the mobile telecommunications network server 840 may share portions of the access application 575 where the mobile communication device 500 performs some operations and the mobile telecommunications network 810 performs other operations as appropriate given different operating conditions, for example, network traffic and computing power available at the communication device 500 and at the mobile telecommunications network server 810. There may be a charge or fee for providing the application in whole or in part over the mobile telecommunications network 810.

The four embodiments disclosed herein provide for initiating an unlocking operation in an expeditious manner, without executing an unlock operation that may be tedious or hard to remember. Once unlocked, the four disclosed embodiments provide immediate access to content related to the audible input. Using the mobile communications device as an example, the four disclosed embodiments eliminate a need to execute the unlocking procedure in order to access a number to make a call. In order to call a number from the locked phone, a user may simply press the key having the first letter of the contact name and then speak the contact name. The phone will automatically unlock and provide the information associated with the contact name. This advantageously reduces the steps required to unlock the phone, access contact information, and initiate a call. Recognition of the audible information is enhanced by providing the first character or a limited set of candidates for the first character by way of the initial character input.

As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.”

It should be understood that the foregoing description is only illustrative of the present embodiments. Various alternatives and modifications can be devised by those skilled in the art without departing from the embodiments disclosed herein. Accordingly, the embodiments are intended to embrace all such alternatives, modifications and variances which fall within the scope of the appended claims.

1. A method comprising:
determining that a character input has been recognized by an apparatus;
determining that an audible word starting with the character has been recognized by the apparatus; and
initiating an unlocking operation of the apparatus.

2. The method of claim 1, wherein the unlocking operation comprises at least providing content related to the recognized word.

3. The method of claim 1, wherein the unlocking operation comprises executing a function utilizing content related to the recognized word.

4. The method of claim 1, wherein the unlocking operation comprises executing an application associated with the recognized word.

5. The method of claim 1, wherein determining that a character input has been recognized comprises receiving at least a keystroke.

6. The method of claim 1, wherein determining that a character input has been recognized comprises determining that a last keystroke of a plurality of keystrokes has been recognized as the character input.

7. The method of claim 1, wherein determining that a character input has been recognized comprises determining that a plurality of characters associated with a keystroke have each been recognized as the character input.

8. The method of claim 1, wherein determining that a character input has been recognized comprises determining that a keystroke exceeding a preset time has been recognized as the character input.

9. The method of claim 1, wherein determining that a character input has been recognized comprises receiving a drawn depiction of a character.

10. The method of claim 1, comprising using speech recognition to determine that an audible word starting with the character has been recognized.

11. A non-transitory computer readable medium comprising computer program code configured to execute the method according to claim 1.

12. An apparatus comprising:
at least one a processor; and
at least one memory including computer program code, the at least one memory and the computer program code configured to, with the at least one processor, cause the apparatus at least to:
determine that a character input has been recognized by the apparatus;
determine that an audible word starting with the character has been recognized by the apparatus; and
initiate an unlocking operation of the apparatus.

13. The apparatus of claim 12, wherein the at least one memory and the computer program code are further configured to, with the at least one processor, cause the apparatus at least to provide content related to the recognized word upon completion of the unlocking operation.

14. The apparatus of claim 12, wherein the at least one memory and the computer program code are further configured to, with the at least one processor, cause the apparatus at least to execute a function utilizing content related to the recognized word upon completion of the unlocking operation.

15. The apparatus of claim 12, wherein the at least one memory and the computer program code are further configured to, with the at least one processor, cause the apparatus at least to execute an application associated with the recognized word.

16. The apparatus of claim 12, wherein the at least one memory and the computer program code are further configured to, with the at least one processor, cause the apparatus at least to determine that a character input has been recognized after receiving a keystroke.

17. The apparatus of claim 12, wherein the at least one memory and the computer program code are further configured to, with the at least one processor, cause the apparatus at least to determine that a character input has been recognized by determining that a last keystroke of a plurality of keystrokes has been recognized as the character input.

18. The apparatus of claim 12, wherein the at least one memory and the computer program code are further configured to, with the at least one processor, cause the apparatus at least to determine that a character input has been recognized by determining that a plurality of characters associated with a keystroke have each been recognized as the character input.

19. The apparatus of claim 12, wherein the at least one memory and the computer program code are further configured to, with the at least one processor, cause the apparatus at least to determine that a character input has been recognized by determining that a keystroke exceeding a preset time has been recognized as the character input.

20. The apparatus of claim 12, wherein the at least one memory and the computer program code are further configured to, with the at least one processor, cause the apparatus at least to determine that a character input has been recognized after receiving a drawn depiction of a character.

21. The apparatus of claim 12, wherein the at least one memory and the computer program code are further configured to, with the at least one processor, cause the apparatus at least to utilize a speech recognition module to determine that an audible word starting with the character has been recognized.

22. The apparatus of claim 12, wherein the apparatus is a computing device further comprising:
user interface circuitry and user interface program code configured to control the user interface;
a key configured to provide the character input;
a microphone configured to provide the audible word; and
an application configured to analyze the character input and the audible word, and to initiate an unlocking operation of the apparatus upon determining that the audible word starts with the input character.

23. The apparatus of claim 12, wherein the apparatus is a mobile communications device further comprising:
user interface circuitry and user interface program code configured to control the user interface;
communication circuitry configured to communicate with other devices;
a keypad configured to provide the character input;
a microphone configured to provide the audible word; and
an application configured to analyze the character input and the audible word, and to initiate an unlocking operation of the mobile communications device upon determining that the audible word starts with the input character.

24. A mobile communications network comprising the apparatus of claim 12.

25. The mobile communications network of claim 24, comprising:
at least one mobile communications network server; and
at least one memory including computer program code, the at least one memory and the computer program code configured to, with the at least one network server, cause the mobile communications network at least to deliver an application to the apparatus, the application configured to:
determine that a character input has been recognized by the apparatus;
determine that an audible word starting with the character has been recognized by the apparatus; and
initiate an unlocking operation of the apparatus.

26. The mobile communications network of claim 24, comprising:
at least one mobile communications network server; and
at least one memory including computer program code, the at least one memory and the computer program code configured to, with the at least one network server, cause the mobile communications network at least to provide a service to the apparatus comprising:
determining that a character input has been recognized by the apparatus;
determining that an audible word starting with the character has been recognized by the apparatus; and
initiating an unlocking operation of the apparatus.
